(19) United States
(12) Patent Application Publication
(10) Pub. No.: US 2010/0162967 A1
(43) Pub. Date: Jul. 1, 2010

(54) HEAT EXCHANGER

(76) Inventor: Stephen Taylor, Hull Yorkshire (GB)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/595,615

(22) PCT Filed: Apr. 14, 2008
(86) PCT No.: PCT/GB08/50257

§ 371 Date: Mar. 18, 2010

(30) Foreign Application Priority Data
Apr. 16, 2007 (GB) 0707262.2

(51) Int. Cl. F22B 37/10; B23P 15/26

(52) U.S. Cl. 122/367.1; 29/890.054

(57) ABSTRACT

The invention relates to heat exchangers used in high efficiency condensing boilers, in particular condensing gas boilers, and a method of manufacturing such heat exchangers. The heat exchanger comprises means to promote unidirectional flue gas flow before entering the primary part. This provides advantages in efficiency.

The invention relates generally to heat exchangers and in particular to heat exchangers for use in high efficiency condensing boilers, typically fuelled, for example, by oil or gas.

Conventional heat exchangers for condensing gas boilers typically include a burner for burning a mixture of fuel and air to generate heat, a blower, a fluid input and fluid output and heat transfer means. The burner combusts the mixture of fuel and air and the products of combustion (flue gas) are blown by the blower through the heat transfer means before being exhausted from the heat exchanger to the atmosphere by suitable ducts or similar. The heat transfer means transfers heat energy from the flue gas to a fluid. The fluid is typically water but may be any suitable fluid which requires heat. Known heat transfer means include an arrangement of elongate fins which act to increase the effective secondary area, and direct water-backed primary area, over which heat transfer occurs. The heated water exiting the boiler is used for heating purposes, e.g. in domestic or commercial central heating systems or other industrial heating processes.

Typically, this type of heat exchanger is either tubular, monoblock or sectional in construction.

In tubular form, the burner is located at one end surrounded by radially or concentrically disposed tubes containing water flowing through them. Heat generated by the burner is transferred from the flue gas to the water across the tube walls.

In monoblock and sectional form, the heat exchanger is typically rectangular, comprising a number of individual plates sandwiched together having interlocking fins to extend the secondary area and define flow channels. The burner is located in an upper portion of the heat exchanger and the flue gas is blown through the flow channels by the blower. The heat transfer occurs across the surface of the fins and other surfaces exposed to the hot flue gas flow.

In both arrangements, heat transfer is affected by radiation in the immediate vicinity of the burner and convection thereafter through the heat transfer surfaces from the hotter flue gas to the cooler water, in accordance to the temperature gradient at any point in the heat exchanger.

Condensate is often formed in the secondary part of the sectional heat exchanger, away from the burner, where the temperature of the flue gas falls below its dew point. The condensate typically flows under gravity through the flow channels and exits the bottom of the heat exchanger into a suitable tank or similar.

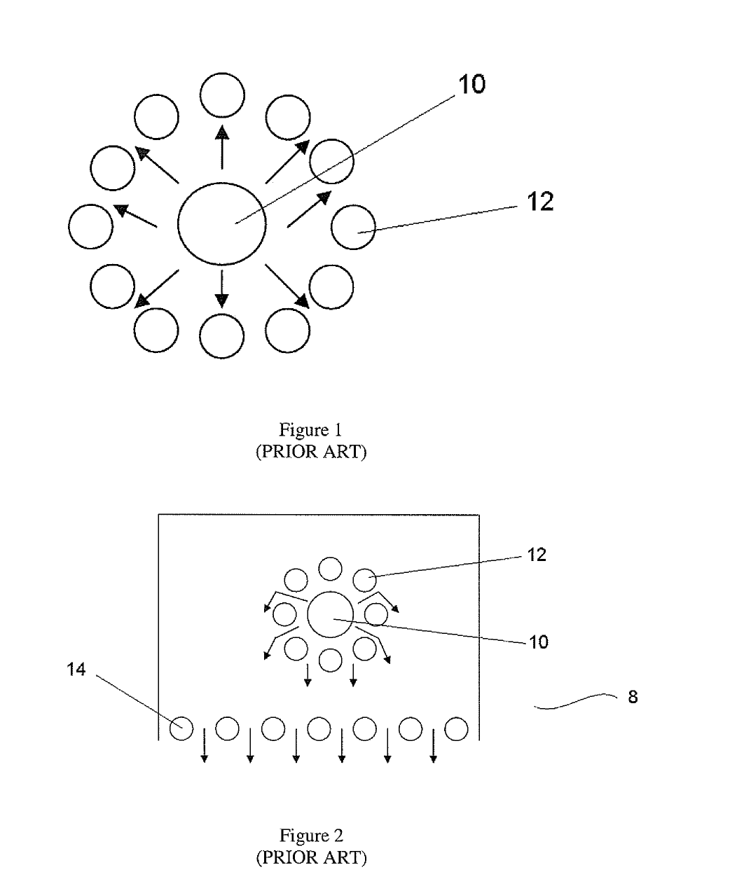

As shown in FIG. 1 of the accompanying drawings, known heat exchangers often include burners (10) featuring 360 degree combustion where the flue gas is blown radially (shown by the arrows) from the burner (10) (non-condensing) through the primary part (12) of the heat exchanger. The primary part (12) typically comprises an arrangement of tubes through which a suitable fluid, e.g. water, flows.

An example of a second arrangement is shown in FIG. 2. In an attempt to improve the efficiency of the heat exchanger, it has been known to provide a condensing heat transfer surface by combining the features of FIG. 1 with a unidirectional secondary part (14) through which the flue gas flows in one direction (shown by the arrows) before exiting the heat exchanger (8). Condensation occurs in this secondary part (14). A significant disadvantage of this arrangement is associated with the point at which the flue gas flow changes direction, from being radial flow from the burner (10) to being unidirectional in the secondary part (14). The change in direction of flue gas flow occurs significantly after the primary part (12) of the heat exchanger. Immediately after the flue gas leaves the burner (10), its temperature is dropping towards the dew point, at which condensation of the flue gas occurs. The drop in temperature is wasted heat loss which could have been effectively transferred to the water. This wasted temperature may therefore be detrimental to the efficiency of the heat exchanger (8).

Another disadvantage of known heat exchangers is associated with the location of the water input and output relative to the burner. One of the water input or output is generally located near to the burner. Where the water input is located near the burner, heat is transferred to the water but is cooling as it flows away from the burner, this being detrimental to the efficiency of the heat exchanger. Where the water output is located near the burner, the period at which heat transfer is most efficient, i.e. in the vicinity of the burner where flue gas temperature is a maximum, is short. This is also detrimental to the efficiency of the heat exchanger.

A further disadvantage of known heat exchangers is associated with the directions of condensate and flue gas flow. Known heat exchangers are arranged so the flue gas from the burner flows upwards against the flow of condensate. This may prevent the condensate from leaving the heat exchanger and, again, cause some detriment to its efficiency.

The entry position and flow characteristics of the water flowing through the heat exchanger are also important factors to ensure maximum heat transfer takes place at any given point within the heat exchanger. As known in the art, the velocity of fluid flow closely affects the efficiency of heat transfer.

Improved heat exchangers are required. Desirably, such heat exchangers would include one or more of the following features:
means to promote unidirectional flue gas flow in the primary part;
means to delay the point at which the flue gas flow enters the secondary part;
means to delay the point at which the dew point of the flue gas is reached;
a burner location away from the water input and output;
flue gas flow in same direction as condensate flow;
maximise heat transfer area;
maximise flue gas velocity;
compact and non-complex to manufacture; and
means to promote condensate removal from any part of the heat exchanger.

According to a first aspect, the present invention provides a heat exchanger for use in a condensing gas boiler comprising:
a plurality of heat exchanger sections arranged parallel to one another, each heat exchanger section comprising at least one internal flow passage having an inlet and an outlet for passage of a heat exchange medium and a plurality of elongate fins formed or provided on at least one side face of each heat exchanger section to define flue gas flow channels between adjacent heat exchanger sections;
a burner to produce a hot flue gas;
means to guide the flue gas from the burner through the flow channels from a primary part to a secondary part of the heat exchanger; and
means to promote unidirectional flue gas flow before entering the primary part.

The elongate fins of each section may be arranged to interlock with the elongate fins of an adjacent section to define said flue gas flow channels.

Preferably the burner is located within an aperture extending through the plurality of heat exchanger sections in a direction perpendicular to said flue gas flow channels. However, a burner located at one end of the heat exchanger may be advantageous in particular applications.

Advantageously, promoting unidirectional flow before the primary part ensures heat transfer occurs as soon as possible after the flue gas leaves the burner when the temperature of the flue gas is at a maximum. This feature provides to maximise the heat transfer efficiency of the heat exchanger.

Preferably, the promotion means changes the flue gas flow from radial flow leaving the burner to unidirectional flow into the primary part. It has been found that heat transfer occurs more efficiently across the heat transfer surface during unidirectional flue gas flow than radial flue gas flow. Promoting unidirectional flow as soon as possible after the flue gas leaves the burner increases the efficiency of the heat exchanger.

Suitably, the promotion means changes the flue gas flow direction from a downward flow to an upward flow. At the same time, the flue gas may absorb radiated heat from the combustion process of the burner.

Advantageously, this change of direction delays the point at which the flue gas flows downwards and away from the burner. As soon as the flue gas flows away from the burner, where temperature is at a maximum, its temperature is decreasing towards its dew point, at which condensation occurs.

Suitably, the promotion means may be a form of barrier to the flow.

Preferably, the barrier is a curved, U-shaped wall which entrains the radial flow of flue gas flow leaving the burner into upward, unidirectional flue gas flow.

Preferably, the promotion means further comprises a plurality of the elongate fins disposed between, and parallel to, vertical arms of the U-shape.

Advantageously, the elongate fins between the vertical arms provide means for heat transfer, affected by convection, in the vicinity of the burner where the flue gas temperature is at a maximum. This increases the efficiency of the heat exchanger.

Suitably, the elongate fins between the vertical arms interlock with corresponding elongate fins on one or more neighbouring sections of the heat exchanger and define flow channels for the flue gas to flow through.

Preferably, the elongate fins are equally spaced and vertically aligned to define equally spaced and vertically aligned channels. This provides for uniform flue gas flow and efficient heat transfer throughout the heat exchanger. As the flue gas flows down the vertically aligned channels and reaches it dew point, condensate will be formed on the heat transfer surface. The condensate flows down the channels under gravity and exits the heat exchanger via suitable means, e.g. ducting or into a tank. Advantageously, the flue gas and condensate flow in the same direction ensuring the condensate flow is not impeded by the flue gas flow which could prevent it leaving the heat exchanger.

In addition, at least one hole may be suitably provided at the base of the ‘U’ shaped wall to allow drainage of condensate without significantly affecting the general direction of flue gas flow and efficiency performance.

The equally spaced and vertically aligned elongate fins also allow for ease of cleaning using suitable cleaning means, e.g. a cleaning brush or scraper.

Suitably, the elongate fins are spaced to provide a high density of fin spacing. This advantageously ensures the heat transfer area is a maximum within the boundaries of the heat exchanger. Also, high density spacing provides narrow flow channels ensuring high flue gas velocity through the heat exchanger for efficient heat transfer.

Preferably, the heat exchanger comprises a front heat exchanger section, a back heat exchanger section and one or more intermediate heat exchanger sections sandwiched between the front and back sections. The one or more intermediate sections may however be omitted to achieve a low heat output unit.

Suitably, the intermediate sections are identical to the front and back sections in respect of, each having interlocking vertically aligned and equally spaced elongate fins formed thereon to define flue gas flow channels. This provides for substantially similar flue gas flow in the flow channels formed between each section and allows for extension of the heat exchanger, particularly when an increase in heat transfer is required, e.g. where the output of the heat exchanger requires increasing, by the addition of further heat exchanger sections.

Preferably, each of the front, back and intermediate sections comprises a hollow portion defining said at least one internal flow passage.

Preferably, one or more insert is located within said hollow portion for controlling the flow of heat exchange medium therethrough to ensure that the flow rate of the fluid throughout each heat exchanger section is substantially proportional to the heat transfer at any specific point through the heat exchanger. The heat exchange medium may suitably be water but may be any suitable medium which effectively transfers heat from one point to another. Advantageously, the heat exchange medium flowing between the fluid inlet and fluid outlet is guided by a combination of the inserts and the design of the hollow portion within each section.

Preferably, the inserts are plastic. However, any suitable material may be used which can be formed by a suitable manufacturing process, e.g. injection moulding, and which is resistant to corrosion. The inserts may be hollow to increase the heat capacity of the fluid flowing through the hollow portion of each section.

Preferably, the at least one fluid inlet is disposed at or near the bottom of either the front or back sections and the at least one fluid outlet is disposed at or near the top of the other. This feature advantageously ensures the flue gas flows in an opposite direction to the fluid in a majority of the heat exchanger. The fluid flowing through the heat exchanger increases in temperature as it flows up the heat exchanger towards the burner where the temperature of the flue gas is at a maximum. In conventional heat exchangers, in which the flue gas and fluid flow in the same direction, the effective heat transfer is less efficient because the flue gas is cooling as it flows through the heat exchanger meaning maximum heat transfer is only achieved at the point of entry of the fluid. This is not the case in the present invention which achieves high efficiency heat transfer by providing counter-flow heat transfer over the majority of the heat exchange surface.

Preferably, the heat exchanger is substantially square. This provides for high density fin spacing within limited boundaries of the heat exchanger and maximises the heat transfer area and the efficiency of the heat exchanger. This also maximises the space utilised within any suitable cabinet.

Preferably, the burner is mounted in the front or back section and located at or near the centre of the section. The burner may be flat, cylindrical, conical or other suitable geometry adequate for the application. Suitably, where the burner is elongate, a longitudinal axis of the burner is perpendicular to the section.

Preferably, the heat exchanger is aluminium but may be any suitable material which efficiently transfers heat from one fluid to another across a boundary formed from the material.

Preferably, the heat exchanger is die-cast aluminium. This allows the heat exchanger to be manufactured using improved joining techniques, e.g. friction stir welding. Using this type of welding, particularly to seal the water- and flue-ways, advantageously forms a homogenic section without the need for any additional welding materials, fillers or fluxes or such like. In addition, the temperature induced in the base material during the welding process is kept to a minimum. This ensures the material does not reach its melting point enabling the plastic inserts to be disposed in the vicinity of the joint being welded.

The use of friction stir welding during the manufacturing process may further eliminate the need for tie rods, or other known joining methods, to secure the sections of the heat exchanger together.

Alternatively, the sections may not be welded together and tie rods may be used. Where tie rods are used, as in conventional heat exchangers, some or all of the tie rods may be eliminated by the use of a connecting means extending through each of the fluid inlets and/or outlets of each section of the heat exchanger. This connecting means may suitably comprise a fluid distribution tube adapted to clamp the sections securely together, having openings along its length which communicate with the hollow portions of each section. The fluid distribution tube may be disposed in the fluid inlets of each section and be adapted to allow the fluid to pass along the tube and into each hollow section. The fluid distribution tube may be disposed in the fluid outlets and be adapted to allow the fluid to pass from the hollow portion of each section into the tube.

The fluid distribution tube may suitably have suitably adapted ends which extend from the inlet or outlet of the front and back sections of the heat exchanger. The suitably adapted ends may comprise threaded ends which accept corresponding nuts which interface with the front and back sections to clamp the sectional heat exchanger together.

In addition to eliminating the need for some or all of the tie rods used in conventional heat exchangers, the use of a fluid distribution tube, or similar, reduces the number of components making up the heat exchanger and also provides for less complex and inexpensive manufacture.

A condensing gas boiler comprising a heat exchanger as herein described is also provided.

One aspect of the present invention will now be described, by way of example only, with reference to the accompanying drawings, in which:

FIG. 1 is a schematic illustration showing a known heat exchanger including a radial primary part;

FIG. 2 is a schematic illustration showing a known heat exchanger including a radial primary part and unidirectional secondary part;

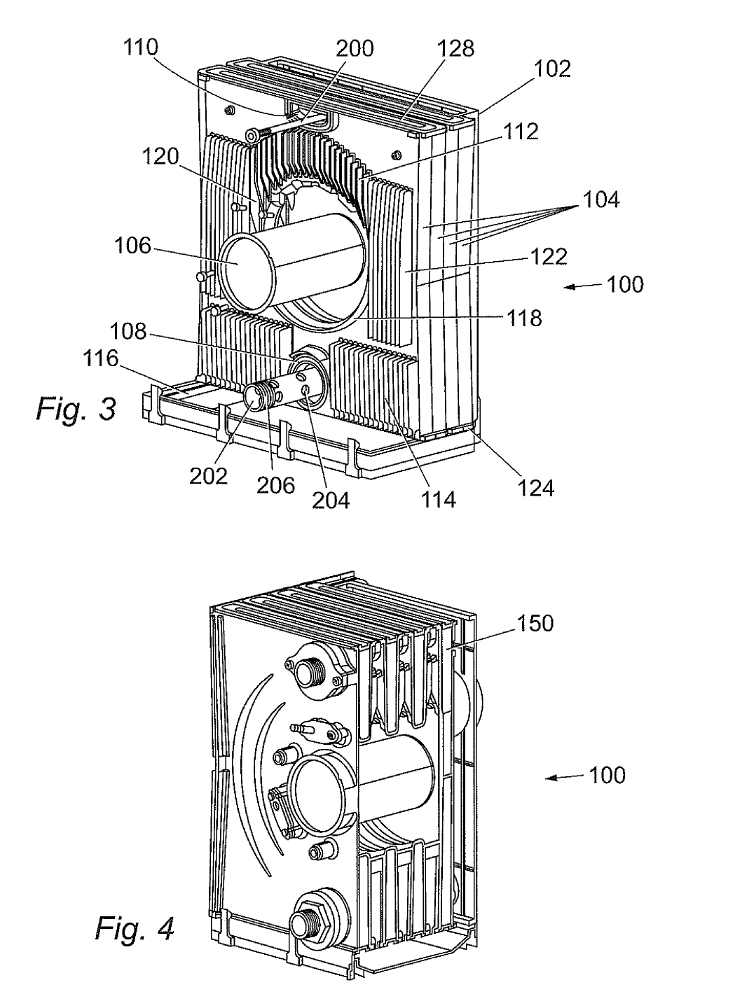

FIG. 3 is a 3D CAD drawing showing a first embodiment of a heat exchanger according to the present invention with the front section, and a number of intermediate sections, removed;

FIG. 4 is a 3D CAD drawing showing a section through the heat exchanger of FIG. 3;

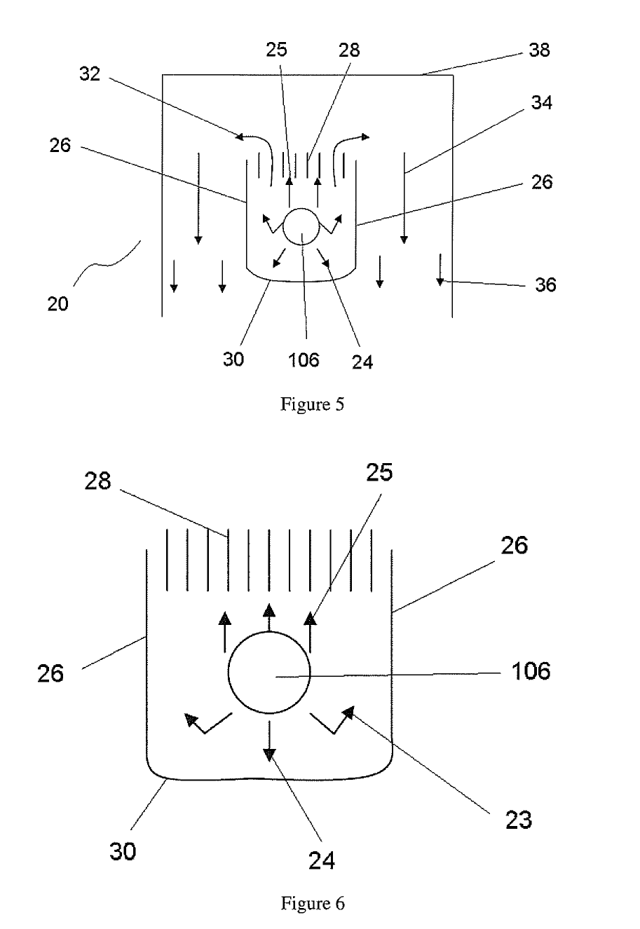

FIG. 5 is a schematic illustration of the heat exchanger of FIGS. 3 and 4;

FIG. 6 is a schematic illustration showing the primary part of the heat exchanger of FIG. 5;

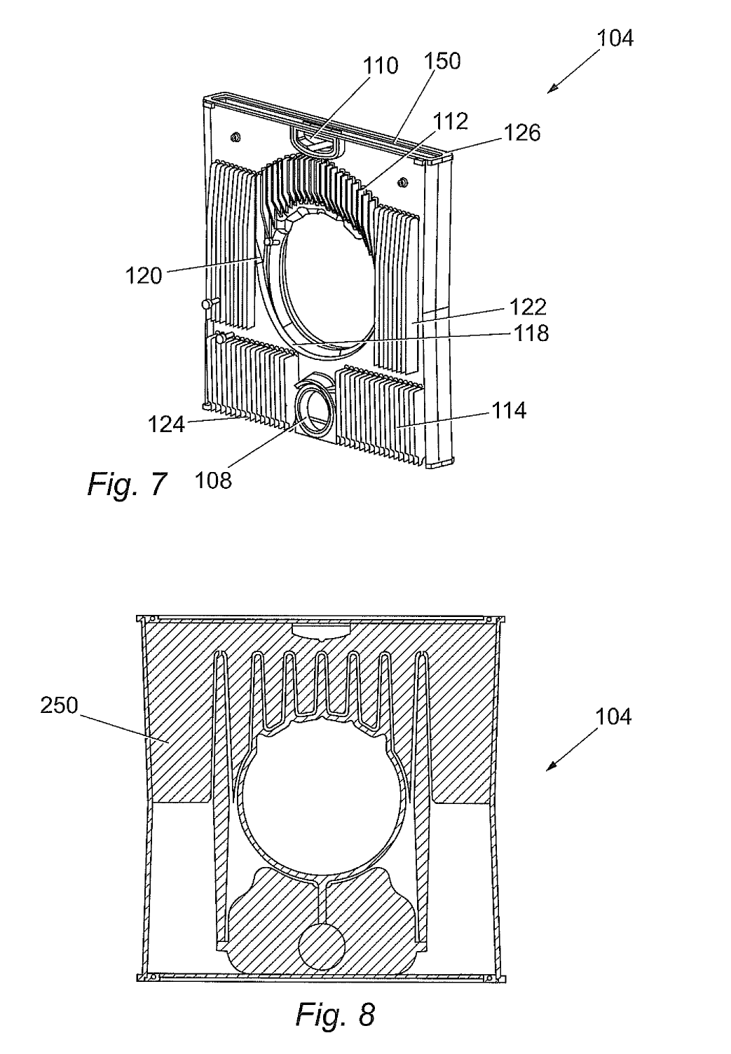

FIG. 7 is an isometric view of one section of the heat exchanger of FIGS. 3 and 4; and

FIG. 8 is a front view of one section of the heat exchanger of FIGS. 3 and 4 showing the plastic fluid flow inserts in situ.

As shown in FIG. 3, a heat exchanger (100) for use in a condensing gas boiler comprises a front section (removed and not shown), a back section (102) and a plurality of intermediate sections (104) sandwiched and securely clamped between the front (not shown) and back (102) sections. An intermediate section (104) is shown in FIG. 7. Each section has interlocking elongate fins (122) which define flow channels. A burner (not shown) is mounted centrally on the front (not shown) or back (102) section and generates hot flue gas when a mixture of air and fuel is ignited and combusted. The flue gas is blown by a blower (not shown) along a suitable flue duct (106) before leaving the flue duct and entering each of the sections. The flue gas flows through the flow channels before exiting the heat exchanger (100) to the atmosphere via suitable means.

Each section has a fluid input (108) at or near a lower edge (124) of the heat exchanger (100) and a fluid output (110) at or near an upper edge (126). The fluid is preferably water but may be any suitable fluid which efficiently transfers heat from one point to another. The water flows through hollow portions (150), as shown in FIG. 4, within each section which are separate and sealed from the flue gas flow channels defined by the interlocking fins (122). Heat is transferred from the flue gas to the water via the interlocking fins (122).

As described above, heat transfer has been found to most efficient when the flue gas is flowing uni-directionally over the surface across which heat transfer occurs and additionally, the heat exchanger is arranged to give counterflow heat transfer where cooler flue gas exchanges heat to the cooler inlet fluid. Promoting unidirectional flow as soon as possible after the flue gas leaves the combustion chamber is beneficial to the efficiency of the heat exchanger (100).

To promote unidirectional flue gas flow before entering the primary part, a U-shaped wall (118) is provided below the burner (106). The U-shaped wall (118) has vertical arms (120) which extend, beyond the burner (106), towards the upper edge (126) of the heat exchanger (100). A plurality of equally spaced, elongate fins (112) are arranged vertically between the vertical arms (120). As with the elongate fins (122), the U-shaped wall (118), vertical arms (120) and elongate fins (112) are adapted to interlock or interconnect with corresponding walls, arms and fins on neighbouring sections of the heat exchanger (100).

As shown in FIGS. 5 and 6, the flue gas flows radially (shown by arrows 24) on leaving the burner (106). A lower portion of the radial flow, flowing downward from the burner (106), is forced to change direction (arrows 23) and to flow upward on meeting the U-shaped wall (30). The vertical arms (26) and elongate fins (28) promote unidirectional flow (shown by arrows 25) of the flue gas entering the primary part of the heat exchanger (20), i.e. in the vicinity of the burner (106) where the flue gas temperature is at a maximum.

The unidirectional flue gas flows up through the flow channels (arrows 25) of the primary part and is then forced to change direction (shown by arrows 32) on approaching the upper edge (38) of the heat exchanger (20). The flue gas flows down (arrows 34) through the flow channels past the burner (106) before entering the secondary part of the heat exchanger (20).

The temperature of the flue gas in the secondary part of the heat exchanger (20) is around the dew point of the flue gas, at which point the flue gas condenses and condensate is formed on the heat transfer surface of the elongate fins (not shown) in the secondary part. The condensate flows under gravity through the flow channels in the secondary part before exiting the heat exchanger into a tray (116), as shown in FIG. 3. Other suitable collecting means may be used such as ducting, a reservoir or tank.

Advantageously, the flue gas flows in the same direction as the condensate and, as a result, the condensate flow is not prevented from leaving the heat exchanger. A hole or holes may be provided at the base of the U-shaped wall (30) to allow drainage of any condensate without significantly affecting the general direction of flue gas flow and efficiency performance.

As shown in FIG. 3, the front (not shown), back (102) and intermediate (104) sections of the heat exchanger (100) are securely clamped together by suitable means. Such means may include tie rods suitably located around the sections which extend through the sections to clamp them together. Alternatively, a single tie rod (200) is disposed through the fluid outlets (110) of each section to clamp the upper parts of the sections together. A fluid distribution tube (202) having threaded ends (206) and openings (204) is disposed through the fluid inlets (108) of each section. A nut (not shown) is threaded onto the threaded ends (206) to clamp the lower parts of the sections together. The openings (204) along the length of the fluid distribution tube (202) are so positioned to distribute fluid into the hollow portions (150, with reference to FIGS. 4 and 7) of each section. The use the fluid distribution tube (202) eliminates the need for a number of tie rods to clamp the sections together and reduces the total number of components required in the heat exchanger, resulting in lower costs and less complex manufacture.

With reference to FIG. 8, the hollow portions (150) are adapted to accept a plurality of inserts (250), each insert defining a profile to ensure that the fluid volume and velocity through each section (104) is substantially proportional to the heat transfer at any specific point through the heat exchanger. Advantageously, the fluid flow path between the fluid inlet and fluid outlet is guided by a combination of the inserts (250) and the design of the hollow portion (150) within each section (104).

The inserts (250) are preferably plastic, however, any suitable material may be used which can be formed by a suitable manufacturing process, e.g. injection moulding, and which is resistant to corrosion.

The heat exchanger is preferably aluminium but may be any suitable material which efficiently transfers heat from one fluid to another across a boundary formed from the material. Preferably, the heat exchanger is die-cast aluminium. This allows the heat exchanger to be manufactured using improved joining techniques, e.g. friction stir welding, with the added benefits as described above, including high accuracy and consistent performance.

What is claimed is:

1. A heat exchanger for use in a condensing gas boiler comprising:
a plurality of heat exchanger sections arranged parallel to one another, each heat exchanger section comprising at least one internal flow passage having an inlet and an outlet for passage of a heat exchange medium and a plurality of elongate fins formed or provided on at least one side face of each heat exchanger section to define flue gas flow channels between adjacent heat exchanger sections;
a burner to produce a hot flue gas;
means to guide the flue gas from the burner through the flow channels from a primary part to a secondary part of the heat exchanger; and
means to promote unidirectional flue gas flow before entering the primary part.

2. A heat exchanger according to claim 1, wherein the elongate fins of each section are arranged to interlock with the elongate fins of an adjacent section to define said flue gas flow channels.

3. A heat exchanger according to claim 1, wherein the burner is located within an aperture extending through the plurality of heat exchanger sections in a direction perpendicular to said flue gas flow channels.

4. A heat exchanger according to claim 1, wherein the promotion means changes the flue gas flow from radial flow leaving the burner to unidirectional flow into the primary part.

5. A heat exchanger according to claim 1, wherein the promotion means changes the flue gas flow direction from a downward flow to art upward flow.

6. A heat exchanger according to claim 4, wherein the promotion means is a form of barrier to the flow.

7. A heat exchanger according to claim 6, wherein the barrier is a curved, U-shaped wall which entrains the radial flow of flue gas flow leaving the burner into upward, unidirectional flue gas flow.

8. A heat exchanger according to claim 7, wherein the promotion means comprises a plurality of the elongate fins disposed between, and parallel to, vertical arms of the U-shape.

9. A heat exchanger according to claim 8, wherein the elongate fins between the vertical arms interlock with corresponding elongate fins on one or more neighbouring sections of the heat exchanger and define flow channels for the flue gas to flow through.

10. A heat exchanger according to claim 1, wherein the elongate fins are equally spaced and vertically aligned to define equally spaced and vertically aligned channels.

11. A heat exchanger according to claim 10, wherein the flue gas flows in the same direction as condensate which forms in the vertically aligned flow channels.

12. A heat exchanger according to claim 7, wherein at least one hole is provided at the base of the ‘U’ shaped wall to allow drainage of condensate.

13. A heat exchanger according to claim 1, wherein the elongate fins are spaced to provide a high density of fin spacing and narrow flow channels.

14. A heat exchanger according to claim 1, comprising a front heat exchanger section and a back heat exchanger section.

15. A heat exchanger according to claim 14, wherein the heat exchanger comprises one or more intermediate heat exchanger sections sandwiched between the front and back sections.

16. A heat exchanger according to claim 15, wherein the intermediate sections are identical to the front and back sections in respect of, each having interlocking vertically aligned and equally spaced elongate fins formed thereon to define flue gas flow channels.

17. A heat exchanger according to claim 15, wherein each of the front, back and intermediate sections comprises a hollow portion defining said at least one internal flow passage.

18. A heat exchanger according to claim 17, wherein one or more insert is located within said hollow portion for controlling the flow of heat exchange medium therethrough.

19. A heat exchanger according to claim 18, wherein the heat exchange medium flowing between the fluid inlet and fluid outlet is guided by a combination of the inserts and the design of the hollow portion within each section.

20. A heat exchanger according to claim 18, wherein the inserts are plastic.

21. A heat exchanger according to claim 15, wherein the at least one fluid inlet is disposed at or near the bottom of either the front or back sections and the at least one fluid outlet is disposed at or near the top of the other.

22. A heat exchanger according to claim 1, wherein the heat exchanger is substantially square.

23. A heat exchanger according to claim 15, wherein the burner is mounted in the front or back section and located at or near the centre of the section.

24. A heat exchanger according to claim 1, comprising connecting means extending through each of the fluid inlets and/or outlets of each section of the heat exchanger.

25. A heat exchanger according to claim 17, wherein the connecting means comprise a fluid distribution tube adapted to clamp the sections securely together, having openings along its length which communicate with the hollow portions of each section.

26. A heat exchanger according to claim 25, wherein the fluid distribution tube comprises suitably adapted ends which extend from the inlet or outlet of the front and back sections of the heat exchanger.

27. A heat exchanger according to claim 26, wherein the suitably adapted ends comprise threaded ends which accept corresponding nuts which interface with the front and back sections to clamp the sectional heat exchanger together.

28. A heat exchanger according to claim 1, wherein the heat exchanger is die-cast aluminium.

29. A method of manufacturing a heat exchanger according to claim 28, wherein the method comprises the step of friction stir welding.

30. A condensing gas boiler comprising a heat exchanger as claimed in claim 1.
